(19) United States
(12) Patent Application Publication
(10) Pub. No.: US 2024/0090672 A1
(43) Pub. Date: Mar. 21, 2024

(54) SEAT SUPPORT

(71) Applicant: Tao Song, Ganzhou City (CN)

(72) Inventor: Tao Song, Ganzhou City (CN)

(21) Appl. No.: 18/512,043

(22) Filed: Nov. 17, 2023

Related U.S. Application Data
(63) Continuation-in-part of application No. 18/099,239, filed on Jan. 19, 2023, now Pat. No. 11,858,397.

(30) Foreign Application Priority Data
Sep. 20, 2022 (CN) 202222494353.4

(51) Int. Cl. A47C 7/52; B60N 3/06

(52) U.S. Cl. CPC A47C 7/52; B60N 3/06

(57) ABSTRACT

The present disclosure provides a seat support applied to a vehicle, the vehicle has a front seat assembly and a back seat assembly. The seat support includes a support member, a connecting member and a fixing assembly. The support member includes a support portion arranged on the back seat assembly. The connecting member is arranged on the support portion and configured to connect the support portion with the front seat assembly. The fixing assembly is arranged on the support portion and configured to fix the support portion with the back seat assembly.

### CROSS REFERENCE TO RELATED APPLICATIONS

This application is a continuation-in-part of application Ser. No. 18/099,239 filed on Jan. 19, 2023, the entire disclosure of which is hereby incorporated by reference herein.

### FIELD

This present disclosure relates to supports, and in particular to a seat support for use in conjunction with seats during travel.

### BACKGROUND

Travelling has become a very common part of life. People often travel for long periods during which time they are seated in a chair and are generally sedentary. In particular, travelling in airplanes requires a passenger to be seated in a cramped position for many hours; travelling in trains, buses and the like can further see a passenger seated for long periods of time in awkward and uncomfortable positions.

Sitting for long periods can become very uncomfortable and can lead to tired and aching muscles, swollen legs, deep vein thrombosis (DVT) and even the life threatening condition of pulmonary emboli. Furthermore, it can be difficult to sleep in an upright seated position and travelers can often become sleep deprived. All of these factors make travelling for long periods uncomfortable.

Accordingly, it would be advantageous of the present disclosure to provide a technical solution which ameliorates one or more of the disadvantages set forth above or at least provide the public with a useful choice.

### SUMMARY

In a first aspect, the present disclosure provides a seat support applied to a vehicle, the vehicle has a front seat assembly and a back seat assembly. The seat support includes a support member, a connecting member and a fixing assembly. The support member includes a support portion arranged on the back seat assembly. The connecting member is arranged on the support portion and configured to connect the support portion with the front seat assembly. The fixing assembly is arranged on the support portion and configured to fix the support portion with the back seat assembly.

In a second aspect, the present disclosure provides a seat support applied to a vehicle, the vehicle has a front seat assembly and a back seat assembly. The seat support includes a support member, a connecting member, and an adjusting assembly. The support member includes a support portion arranged on the back seat assembly. The connecting member is arranged on the support portion and configured to connect the support portion with the front seat assembly. The adjusting assembly is configured to connect the support portion with the connecting member at a region of the support portion to prevent the support portion from sagging.

In a third aspect, the present disclosure provides a seat support applied to a vehicle, the vehicle has a front seat assembly and a back seat assembly. The seat support includes a support member, a connecting member, and an adjusting assembly. The support member includes a support portion arranged on the back seat assembly. The connecting member is arranged on the support portion and configured to connect the support portion with the front seat assembly. The adjusting assembly is configured to connect the support portion with the front seat assembly at a portion of the support portion according to a gap between the front seat assembly and the back seat assembly to prevent the support portion from sagging.

### BRIEF DESCRIPTION OF THE DRAWINGS

Implementations of the present disclosure will now be described, by way of embodiment, with reference to the attached FIGS. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structural diagram of a seat support according to a first embodiment of the present disclosure;

FIG. 2 is another structural diagram of the seat support in FIG. 1;

FIG. 3 is a structural diagram of the seat support in FIG. 1, wherein each of the first connecting member and the second connecting member is in a connected state;

FIG. 4 is a structural diagram of the seat support in FIG. 1, and the seat support is fixed to front and back seats;

FIG. 5 is another structural diagram of the seat support in FIG. 1, and the seat support is fixed to front and back seats;

FIG. 6 is a structural diagram of a seat support according to a second embodiment of the present disclosure;

FIG. 7 is a structural diagram of a seat support according to a third embodiment of the present disclosure;

FIG. 8 is a structural diagram of the seat support in FIG. 7, wherein the first connecting member is in a connected state;

FIG. 9 is a structural diagram of a seat support according to a fourth embodiment of the present disclosure;

FIG. 10 is a structural diagram of the seat support in FIG. 9, wherein the first connecting member and the second connecting member are in a connected state;

FIG. 11 is a structural diagram of the seat support in FIG. 9, and the seat support is fixed to front and back seats;

FIG. 12 is a structural diagram of a seat support according to a fifth embodiment of the present disclosure;

FIG. 13 is a structural diagram of a seat support according to a sixth embodiment of the present disclosure;

FIG. 14 is a structural diagram of a seat support according to a seventh embodiment of the present disclosure;

FIG. 15 is a structural diagram of a seat support according to an eight embodiment of the present disclosure;

FIG. 16 is a structural diagram of a seat support according to a ninth embodiment of the present disclosure;

FIG. 17 is a structural diagram of a seat support according to a tenth embodiment of the present disclosure;

FIG. 18 is a structural diagram of an airbag of the seat support in FIG. 17;

FIG. 19 is a structural diagram of a seat support according to an eleventh embodiment of the present disclosure;

FIG. 20 is a structural diagram of an anti-skid portion and a support portion of the seat support in FIG. 1;

FIG. 21 is a structural diagram of a seat support according to a twelfth embodiment of the present disclosure;

FIG. 22 is cross sectional diagram of the seat support along line A-A as shown in FIG. 21;

FIG. 23 is another structural diagram of the seat support in FIG. 21;

FIG. 24 is a further structural diagram of some parts of the seat support in FIG. 21;

FIG. 25 is a structural diagram of the seat support in FIG. 21, and the seat support is fixed to the front seat assembly and the back seat assembly;

FIG. 26 is a structural diagram of a seat support according to another embodiment, the seat support is fixed to the back seat assembly;

FIG. 27 is a structural diagram of a seat support according to a further embodiment, the seat support is fixed to the back seat assembly;

FIG. 28 is a structural diagram of a seat support according to a thirteenth embodiment of the present disclosure;

FIG. 29 is another structural diagram of the seat support in FIG. 26;

FIG. 30 is a structural diagram of a portion of the seat support in FIG. 26;

FIG. 31 is another structural diagram of the portion of the seat support in FIG. 26;

FIG. 32 is a structural diagram of the seat support in FIG. 26, and the seat support is fixed to the front seat assembly and the back seat assembly;

FIG. 33 is a structural diagram of the sleeve, the adjusting assembly and the support portion according to another embodiment of the present disclosure;

FIG. 34 is a structural diagram of the sleeve, the adjusting assembly and the support portion according to a further embodiment of the present disclosure.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, all of the directional instructions in the exemplary embodiments of the present disclosure (such as top, down, left, right, front, back) can only be configured to explaining relative position relations, moving condition of the elements under a special form (referring to figures), and so on, if the special form changes, the directional instructions change accordingly.

In addition, the descriptions, such as the “first”, the “second” in the present disclosure, can only be configured to describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not exist, and is not contained in the protection scope required by the present disclosure.

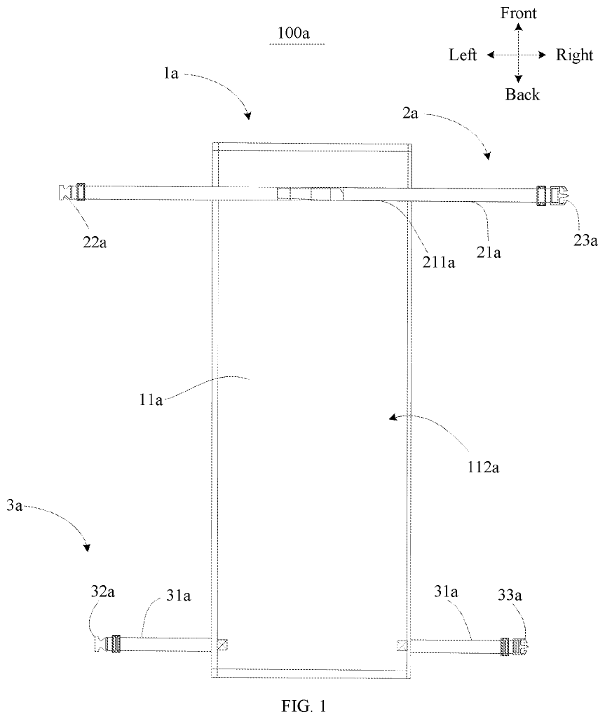

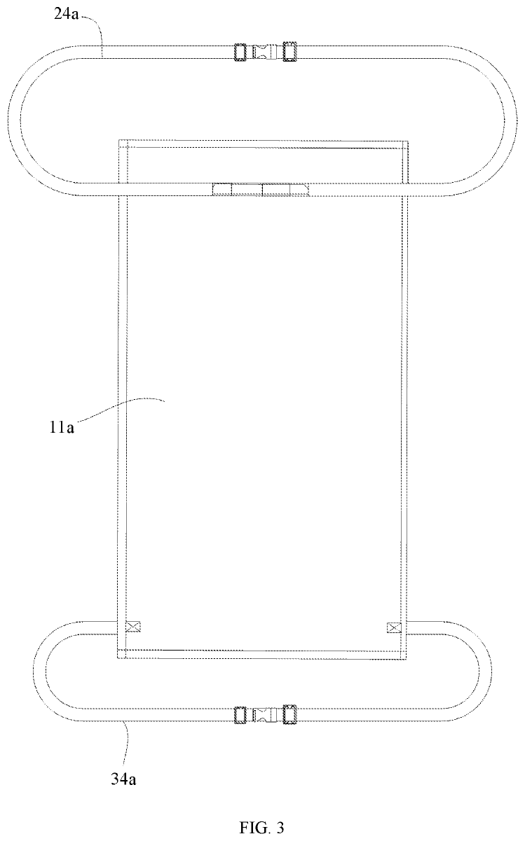

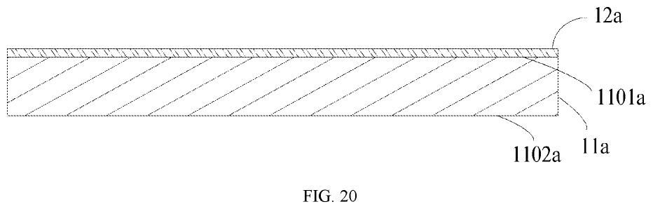

Referring to FIGS. 1-5 and 20, the present disclosure provides a seat support 100a according to a first embodiment.

The seat support 100a includes a support member 1a, a first connecting member 2a and a second connecting member 3a. The support member 1a includes a support portion 11a and an anti-skid portion 12a. The support portion 11a is a sheet, the support portion 11a includes a back side 1101a and a front side 1102a, and the anti-skid portion 12a is arranged on the back side 1101a of the support portion 11a. The first connecting member 2a is fixedly connected with a first end (i.e. a front end) of the support portion 11a, and the first connecting member 2a and the first end of the support member 1a enclose a first connecting portion 24a. The second connecting member 3a is fixedly connected with a second end (i.e. a rear end) of the support portion 11a, and the second connecting member 3a and the second end enclose a second connecting portion 34a. In an embodiment, the anti-skid portion 12a is an anti-skid layer arranged on the back side 1102a, and the anti-skid layer 12a is made of an anti-skid material, such as silicone, rubber, nylon, and woven materials with rough surfaces.

The seat support 100a is connected with the seats of a vehicle, such as a car, a bus, a high-speed train, an airplane, and the like. A part of the seat support 100a is arranged on a seat cushion 2011 of the back seat assembly 201 and connected with a backrest 2013 of the back seat, and another part of the seat support 100a is connected with the front seat assembly 202. An area of the seat support 100a between the seat cushion 2011 and the front seat assembly 202 is regarded as a suspension portion 2012. User can sit on the seat cushion 2011 of the back seat assembly 201, and place legs and foot on the suspension portion 2012. In this way, user's legs are supported and the pressures on the legs are relieved, and the seat support 100a provides the user with a more comfortable seated position or a flat extended base for sleeping. The anti-skid portion 12a on the support member 1a can increase a friction between the support member 1a and the seat cushion 2011. Even if user continuously adjusts his sitting postures, the support member 1a can fit with the seat cushion 2011 orderly. The support portion 11a is a sheet, that is, the support portion 11a is thin, small in size and light in weight, so the seat support 100a can be easily carried when traveling.

Specifically, the first connecting member 2a is fixedly connected with the front seat assembly 202, and the second connecting member 3a is fixedly connected with the back seat assembly 201. In this way, the support member 1a is firmly connected between the back seat assembly 201 and the front seat assembly 202. It should be understood that the first connecting member 2a and the second connecting member 3a are both provided with an adjustment buckle (not labeled), lengths of the first connecting member 2a and the second connecting member 3a can be adjusted to adapt to the seats with different sizes, so the support member 1a is firmly connected between the back seat assembly 201 and the front seat assembly 202. Of course, the first connecting member 2a and the second connecting member 3a can further be elastic, and the sizes of the first connecting member 2a and the second connecting member 3a can further be adjusted.

The first connecting member 2a includes a covering portion 211a covering the support portion 11a, and at least a part of the covering portion 211a is not sewn with the support portion 11a, or the covering portion 211a is completely sewn with the support portion 11a; the covering portion 211a passes or extends through the support portion 11a, and the covering portion 211a is a one-piece structure.

The support member 1a is flatly laid between the front seat assembly 202 and back seat assembly 201, and the first connecting member 2a and the second connecting member 3a are used to fix the support member 1a. The first connecting member 2a is fixedly connected with the front seat assembly 202, and the second connecting member 3a is fixedly connected with the back seat assembly 201. In this way, the support member 1a can be stably arranged between the front seat assembly 202 and the back seat assembly 201, and the suspension portion 2012 of the support member 1a can support user's feet and the legs, thereby alleviating the acid swellings and numbness of the feet and the legs. The anti-skid portion 12a can increase the friction between the support portion 11a and the seat cushion 2011, so that the support portion 11a will not move under a movement of user.

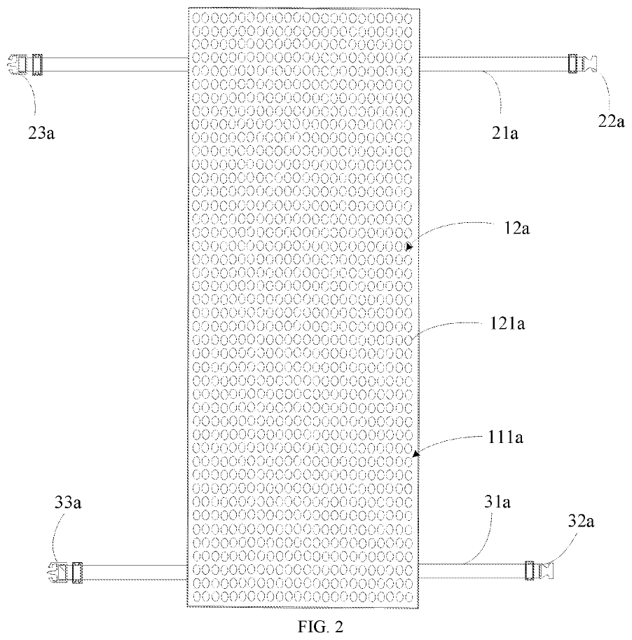

Further, referring to FIGS. 1-2, the support portion 11a is made of flexible material. The support portion 11a includes an inner layer 111a and a surface layer 112a fixedly connected with the inner layer 111a. The anti-skid portion 12a is arranged on the inner layer 111a and protruded from an outer surface of the inner layer 111a. Specifically, a periphery of the inner layer 111a is fixedly connected with a periphery of the surface layer 112a. In one embodiment, areas of the inner layer 111a except the periphery are not separated from areas of the surface layer 112a except the periphery, that is, the inner layer 111a is completely fixedly with the surface layer 112a. In another embodiment, at least a portion of areas of the inner layer 111a except the periphery is fixedly connected with an area of the surface layer 112a except the periphery, that is, the inner layer 111a is not completely fixedly with the surface layer 112a. In a further embodiment, at least a portion of areas of the inner layer 111a except the periphery is separated from an area of the surface layer 112a except the periphery, that is, the inner layer 111a is not completely fixedly with the surface layer 112a.

In order to facilitate the storage and enhance user comfort, the support portion 11a is made of a flexible material. The support portion 11a is preferably made of a breathable flexible material, so it's very breathable for the user's hip, legs and feet. The support portion 11a has a double-layer structure, which is convenient to increase the thickness of the support portion 11a. So that, the user will not feel the presence of the anti-skid portion 12a when sitting on the support portion 11a. Further, it is further conducive to the setting of the anti-skid portion 12a on the thick support portion 11a. When the anti-skid portion 12a is made of plastic materials, the plastic materials are usually injected onto the inner layer 111a, and the inner layer 111a is set thinner, which can facilitate the attachment of plastic materials. It should be understood that in order to further increase the comfort of the support portion 11a, sponge or cotton can be filled between the inner layer 111a and the surface layer 112a.

Further, please referring to FIG. 2, the inner layer 111a is made of flexible material, such as cloth, fiber, paper cloth, velvet, polyurethane, PVC (Polyvinyl Chloride) flocking, etc. The periphery of the inner layer 111a is fixedly connected with the periphery of the surface layer 112a. The anti-skid portion 12a is arranged on the outer surface of the inner layer 111a. The inner layer 111a is also fixedly connected to a middle portion of the surface layer 112a.

The anti-skid portion 12a includes a plurality of anti-skid bumps 121a, which are arranged on the outer surface of the inner layer 111a. The anti-skid bump 121a is made of plastic, silicone, or rubber. The anti-skid bumps 121a are uniformly arranged on the back side; or the anti-skid bumps 121a are randomly arranged on the back side. The anti-skid bump 121a has a diameter of about 0-200 mm, for example, the anti-skid bump 121a has a diameter of 0.1 mm, 1 mm, 2 mm, 3 mm, 4 mm, 5 mm, 10 mm, 50 mm, 100 mm, 150 mm, or 200 mm. The anti-skid bump 121a has a height of about 0-20 mm, for example, the anti-skid bump 121a has a height of 0.1 mm, 0.2 mm, 0.5 mm, 1 mm, 1.5 mm, 2 mm, 5 mm, 10 mm, 15 mm, or 20 mm. A space between two adjacent anti-skid bumps 121a is about 0-200 mm, for example, the space between two adjacent anti-skid bumps 121a is 0.1 mm, 1 mm, 2 mm, 3 mm, 4 mm, 5 mm, 10 mm, 50 mm, 100 mm, 150 mm, or 200 mm. The anti-skid bumps 121a are arranged in a plurality of bump groups, diameters of bumps in each bump groups gradually decrease or increase in a direction from the back seat assembly 201 to the front seat assembly 202, or heights of bumps in each bump groups gradually decrease or increase in a direction from the back seat assembly 201 to the front seat assembly 202.

The cloth material has a good air permeability, and the anti-skid portion 12a can be quickly bonded with the inner layer 111a during injection molding. In order to ensure that the anti-skid portion 12a will not affect the comfort of the seat support 100a, the anti-skid portion 12a is set as a plurality of anti-skid bumps 121a, so that user can hardly feel the presences of the anti-skid bumps 121a even when he is sitting on the support portion 11a.

Further, a thickness of the surface layer 112a is greater than that of the inner layer 111a. The thinner inner layer 111a can facilitate a rapid prototyping of anti-skid bumps 121a, and the thicker surface layer 112a can reduce the presences of anti-skid bumps 121a.

Further, the inner layer 111a and the surface layer 112a are made of flexible material, such as cloth, fiber, paper cloth, polyurethane, PVC (Polyvinyl Chloride) flocking, etc., and the periphery of the inner layer 111a is sewn and fixedly connected with the periphery of the surface layer 112a. The cloth has a good air permeability. Both the surface layer 112a and the inner layer 111a are made of cloth, so the surface layer 112a and the inner layer 111a can be easily stored, carried and cleaned.

Further, both the first connecting member 2a and the second connecting member 3a are fixedly connected with the outer surface of the surface layer 112a of the support portion 11a, to prevent the first connecting member 2a and the second connecting member 2a from affecting the arrangement of the anti-skid portion 12a. In another embodiment, the first connecting member 2a or the second connecting member 3a can also be arranged on an inner surface of the surface layer 112a or an inner surface of the inner layer 111a. In a further embodiment, the first connecting member 2a or the second connecting member 3a can also be arranged on an outer surface of the inner layer 111a.

Further, referring to FIGS. 1 and 2, the first connecting member 2a includes a connecting belt 21a (which can be a long mesh belt) connected with the first end of the support portion 11a, a connecting part 22a (which can be a clamping seat), and a connecting part 23a (which can be a clamping head). A middle section of the connecting belt 21a is at least partially fixed with the support portion 11a, and both ends of the connecting belt 21a extend outside the support portion 11a. In an embodiment, a portion of the middle section of the connecting belt 21a is not fixed with the support portion 11a to form a handle (not labeled). One end of the connecting belt 21a is connected with the connecting part 22a, the other end is connected with the connecting part 23a. When the connecting part 22a is detachably connected with the connecting part 23a, the connecting belt 21a, the connecting part 22a, the connecting part 23a, the support portion 11a enclose the connecting portion 24a. The connecting belt 21a may be connected with the inner layer 111a or the surface layer 112a or connected between the inner layer 111a and the surface layer 112a.

The second connecting member 3a includes two connecting belts 31a (which can be medium length mesh belt), a connecting part 32a (which can be a clamping seat) and a connecting part 33a (which can be a clamping head). One end of each connecting belt 31a is fixedly connected with a corner at the second end of the support portion 11a, and the other end extends out of the support portion 11a. One of the two connecting belts 31a is fixedly connected with the connecting part 32a, the other one is fixedly connected with the connecting part 33a. When the connecting part 32a is clamped with the connecting part 33a, the two connecting belts 31a, the connecting part 32a, the connecting part 33a and the support portion 11a enclose the second connecting portion 34a.

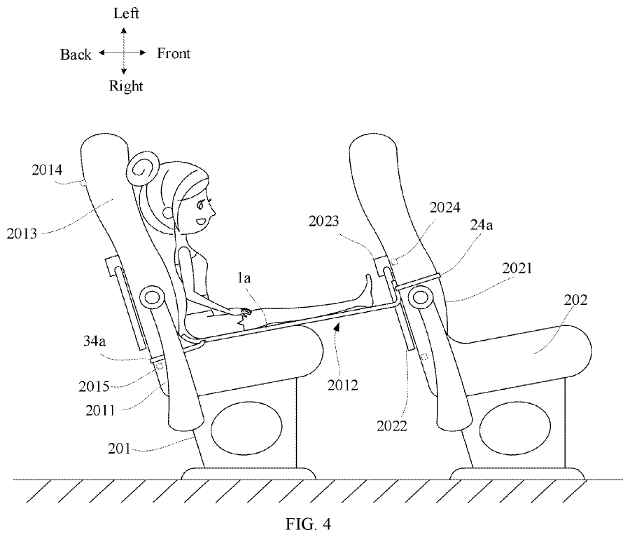

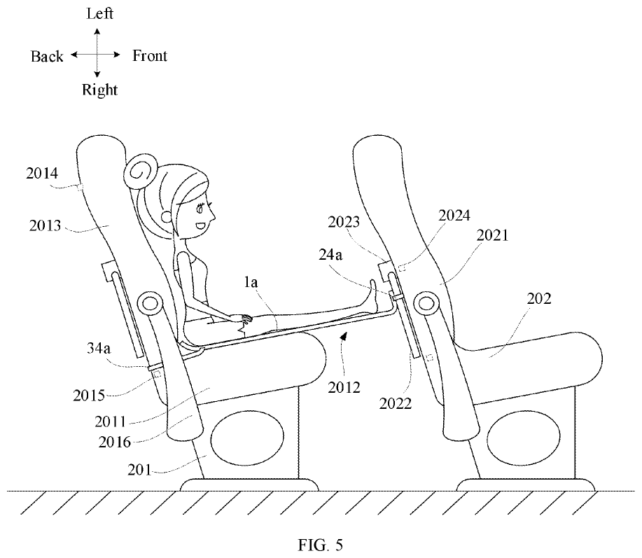

The connecting part 22a is clamped with the connecting part 23a to form a ring shaped connecting portion 24a. The ring shaped connecting portion 24a sleeves on the backrest 2021 of the front seat assembly 202 (see FIG. 4), or sleeves on a table 2022 arranged on the front seat assembly 202 (see FIG. 5), or sleeves on a connecting element 2023 which is configured to rotatably connect the table 2022 with the backrest 2021. In detail, both ends of the connecting belt 21a can pass the backrest 2021 of the front seat assembly 202 from both sides, and then the connecting part 22a is clamped in the connecting part 23a, so that the seat support 100a can be connected with the front seat assembly 202 rapidly. The two second connecting belts 31a may be asymmetrically connected with the support portion 11a, or the two second connecting belts 31a may have different lengths, so seat support 100a has a high fault tolerance. The second connecting belts 31a form an annular second connecting portion 34a by connecting the connecting part 32a with the connecting part 33a. The second connecting portion 34a can sleeve on the back seat assembly 201, to connect the seat support 100a with the back seat assembly 201. The second connecting portion 34a may be installed in the same way as the first connecting portion, so it will not be described here.

It should be understood that the connecting belt 21a and the connecting belt 31a are fixedly connected with the support portion 11a by sewing. In this way, the connecting belt 21a and the connecting belt 31a are relatively stably connected with the support portion 11a. It should be understood that the connecting part 22a is adapted to the connecting part 23a, and the two can be connected and matched with each other. This connection mode is simple and reliable, and is convenient for users to operate.

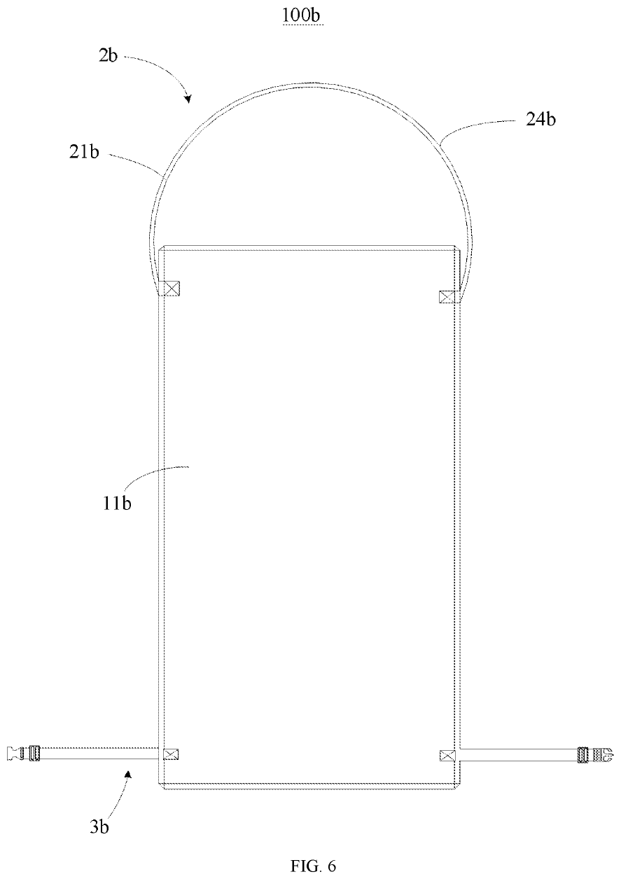

Referring to FIG. 6, the present disclosure provides a seat support 100b according to a second embodiment. The seat support 100b is similar to the seat support 100a in structure, and the differences between the two at least include: the first connecting member 2b is an elastic belt 21b, two ends of the elastic belt 21b are fixedly connected with two corners of the first end of the support portion 11a, and the elastic belt 21b and the support portion 11a enclose the connecting portion 24b.

User can adjust the length of the elastic belt 21b more quickly than the buckle. The two ends of the elastic belt 21b are fixedly connected with the support portion 11b to forms the annular connecting portion 24b which can sleeve on the front seat assembly 202.

The second connecting member 3b is similar with the second connecting member 3a in structure.

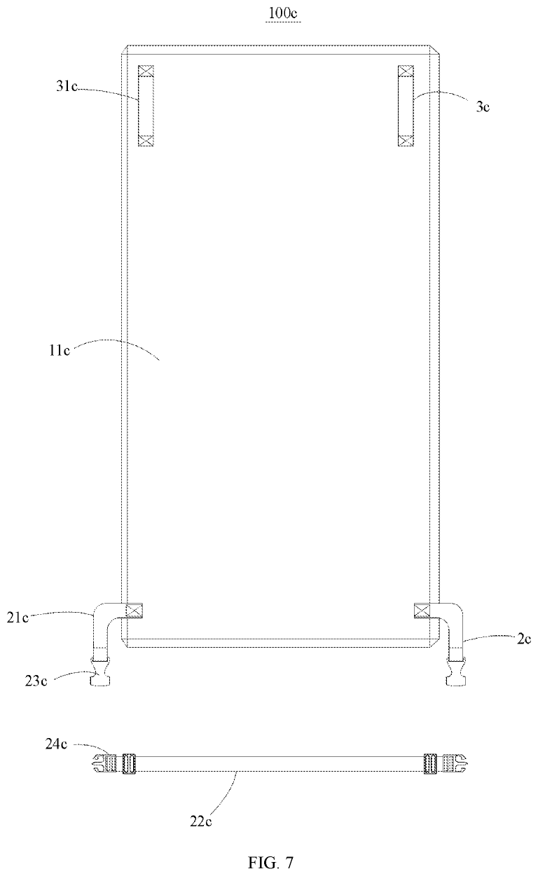

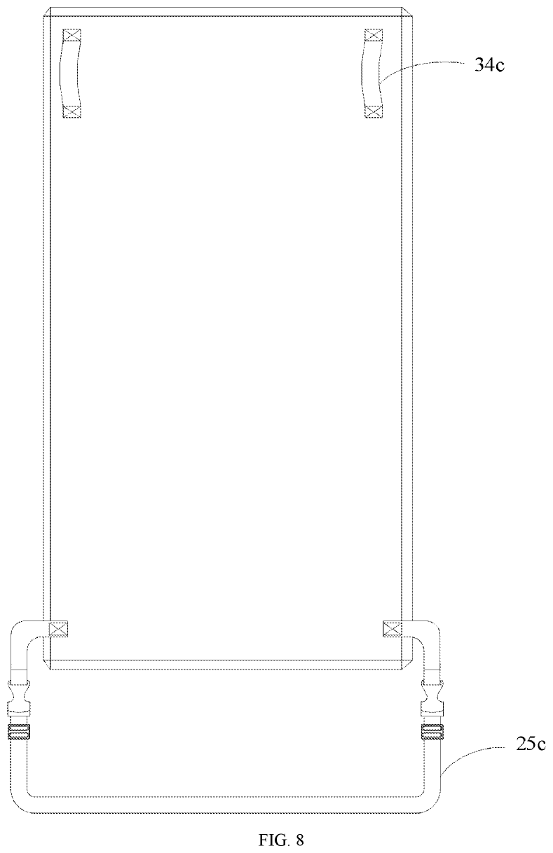

Referring to FIGS. 7-8, the present disclosure provides a seat support 100c according to a third embodiment. The seat support 100c is similar to the seat support 100a in structure, and the differences between the two at least include: the second connecting member 3c includes two connecting belts 31c (which can be short mesh belts), both ends of each connecting belt 31c are fixedly connected with a corner of the second end of the support portion 11c, and a middle portion of each connecting belt 31c is separated from the support portion 11c to form a connecting portion 34c for the safety belt 2016 to pass through; the first connecting member 2c includes two connecting belts 21c (which can be short mesh belts), a connecting belt 22c (which can be a mesh belt with a medium length), two connecting parts 23c (which can be clamping seats), and two connecting parts 24c (which can be clamping heads); ends of the two connecting belts 21c are fixedly connected with two corners of the first end of the support portion 11c, other ends of the two connecting belts 21c bently extend out of the support portion 11c and connect with the two connecting parts 23c respectively; both ends of the connecting belt 22c are respectively connected with two connecting parts 24c; the connecting parts 23c are clamped with the connecting parts 24c; two connecting belts 21c, the connecting belt 22c, the connecting parts 23c, the connecting parts 24c, and the support portion 11c form the connecting portion 25c which can sleeve on the backrest 2021 of the front seat assembly 202 or sleeve on the connecting element 2023 on the rear surface of the backrest 2021 or connect with the table 2022 of front seat assembly 202; ends of the two connecting belts 31c are fixed on the support portion 11c, and the two connecting belts 31c and the support portion 11c cooperatively form the connecting portions 34c; the safety belts 2016 of the back seat assembly 201 can pass through the two connecting portions 34c respectively, and then user fixes the safety belts, so that the second connecting member 3c can further be fixed.

In another embodiment, the second connecting member 3c is the same as the second connecting member 3e, the first connecting member 2a, or the second connecting member 3b.

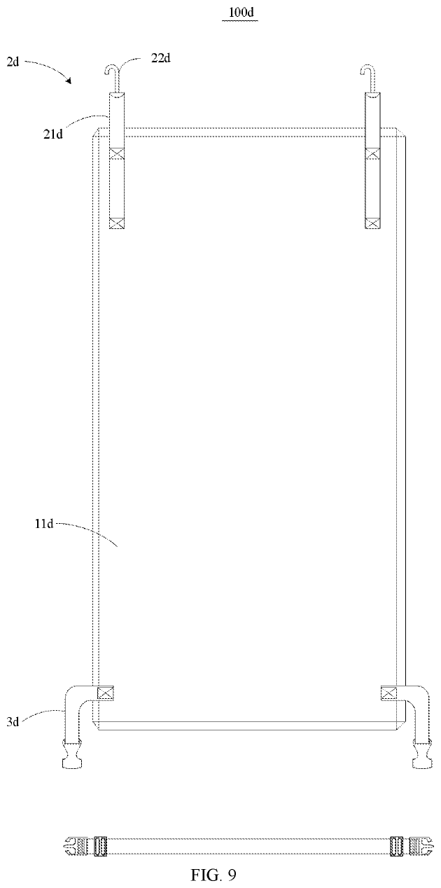

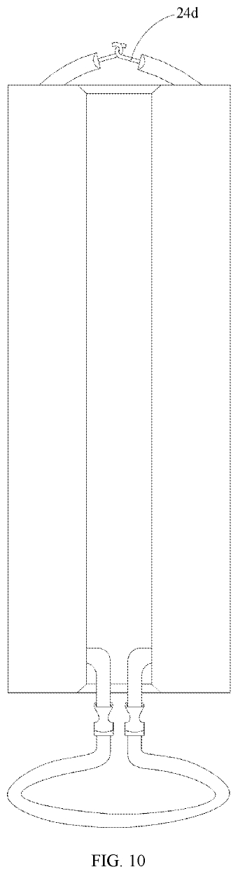

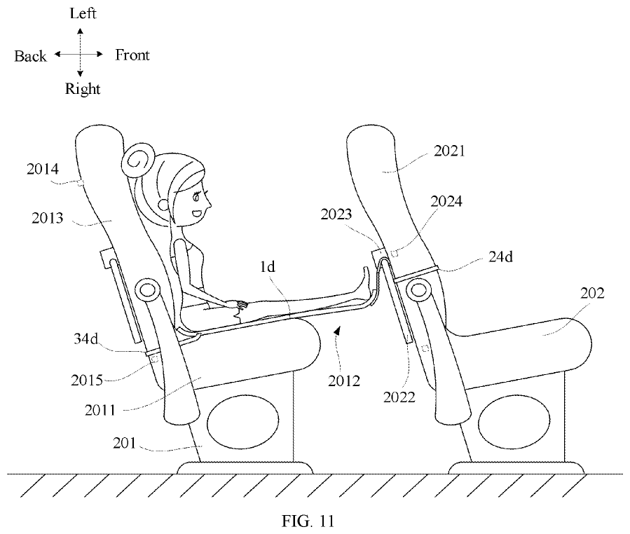

Referring to FIGS. 9-11, the present disclosure provides a seat support 100d according to a fourth embodiment. The seat support 100d is similar to the seat support 100c in structure, and the differences between the two at least include: the first connecting member 2d includes two connecting belts 21d (which can be short mesh belts) and two connecting parts 22d (which can be locking hooks, hangers, etc.); end of the two connecting belt 21d are fixed at two corners of the first end of the support portion 11d, the other ends of the two connecting belts 21d are respectively fixedly connected with the connecting parts 22d.

The connecting parts 22d can be connected with the connecting element 2023 arranged on the backrest 2021 of the front seat assembly 202, or connected with buckles 2024 of the front seat assembly 202 arranged on the side surfaces of the backrest 2021, or connected with the table 2022 of the front seat assembly 202, or sleeve around the backrest 2021 of the front seat assembly 202. The buckles 2024 of the front seat assembly 202 are used for hanging luggage, so the first end of the seat support 100d can be fixed on the front seat assembly 202. It should be understood that the two connecting parts 22d may also be connected to each other to form a connecting portion 24d which is configured to connect with the table 2022 or the connecting element 2023 of the front seat assembly 202.

In an embodiment, the connecting parts 22d can be connected with the buckles 2015 arranged on two sides of the backrest 2013, to connect the seat support 100d with the back seat assembly 201. In another embodiment, the connecting parts 22d are fixed in the gap between the backrest 2013 and the seat cushion 2011, to connect the seat support 100d with the back seat assembly 201.

The second connecting member 3d is similar as the first connecting member 2c in structure.

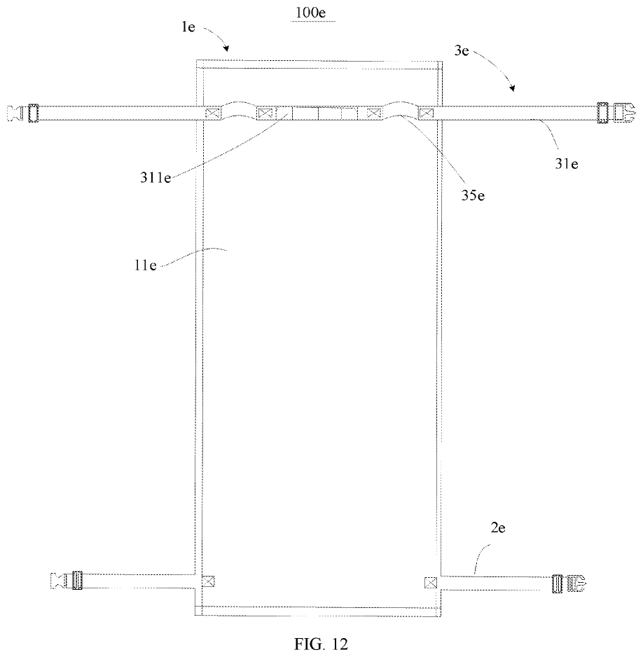

Referring to FIG. 12, the present disclosure provides a seat support 100e according to a fifth embodiment. The seat support 100e is similar to the seat support 100a in structure, and the differences between the two at least include: the connecting belt 31e of the second connecting member 3e includes a covering portion 311e covering the support portion 11e, and at least a part of the covering portion 311e is not sewn with the support portion 11e to form the connecting portion 35e; the covering portion 311e pass through the support portion 11e along a radial direction of the support portion 11e. The covering portion 311e is a one-piece structure.

In an embodiment, two portions of the covering portion 311e are not sewn with the support portion 11e to form two connection portions 35e spaced at intervals.

The safety belts 2016 of the back seat assembly 201 can pass through the two connecting portions 35e respectively, and then user fixes the safety belts 2016. In this way, the two connecting members 3e can further be fixed.

The connecting member 2e is similar with the connecting member 3a in structure.

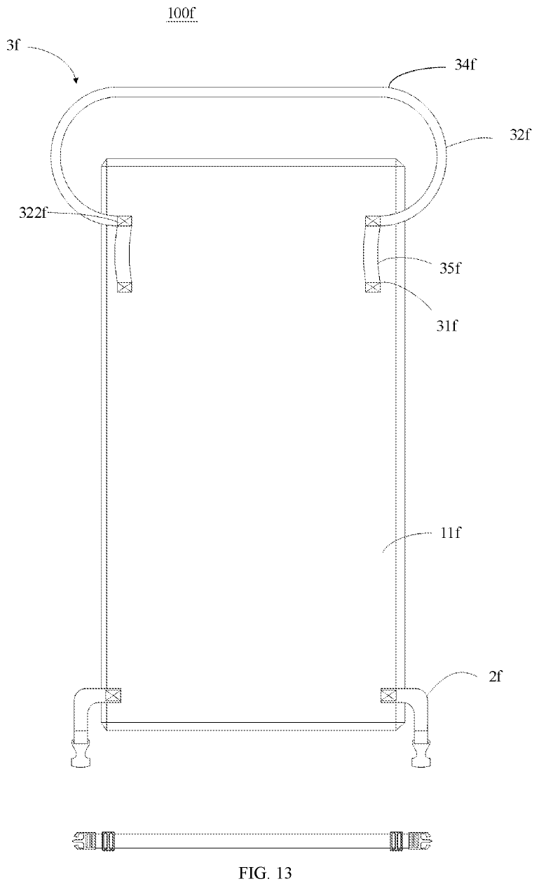

Referring to FIG. 13, the present disclosure provides a seat support 100f according to a sixth embodiment. The seat support 100f is similar to the seat support 100c in structure, and the differences between the two at least include: the second connecting member 3f includes two connecting belts 31f and an elastic belt 32f, and both ends of the elastic belt 32f are respectively connected with both ends of the support portion 11f to form the connecting portion 34f which can sleeve on the backrest 2013; both ends of the connecting belt 31f are connected with the support portion 11f to form the connecting portion 35f for the safety belt 2016 to pass through.

The suturing portion of the elastic belt 32f and the support portion 11f at least partially coincides with the suturing portion of the connecting belt 31f and the support portion 11f.

The connecting member 2f is similar with the connecting member 3d in structure.

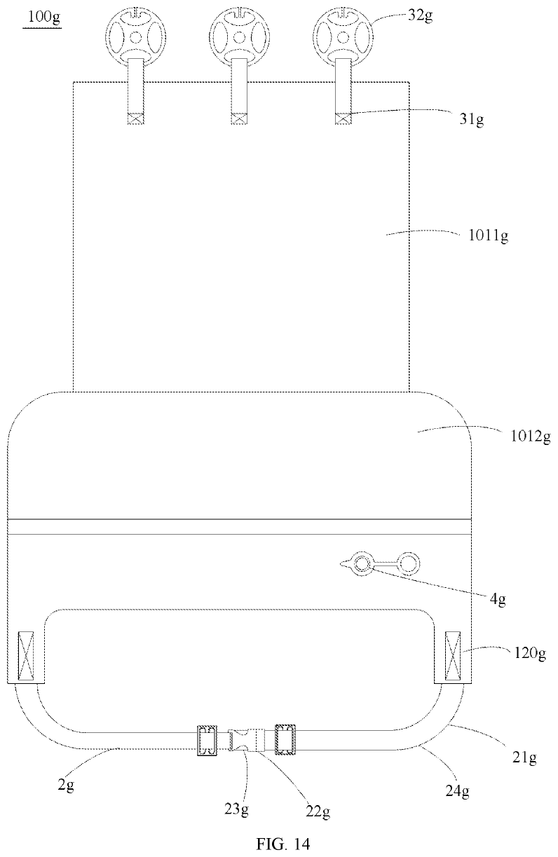

Please referring to FIG. 14, the present disclosure provides a seat support 100g according to a seventh embodiment. The seat support 100g is similar to the seat support 100b in structure, and the differences between the two at least include: the seat support 100g further includes a first sub support 1011g and a second sub support 1012g connected with the first sub support 1011g; the first sub support 1011g is arranged on the seat cushion 2011 of the back seat assembly 201, the second sub support 1012g is connected with the front seat assembly 202 and the first sub support 1011g to form the suspension portion 2012 for supporting the legs and feet; the second connecting member 3g includes at least one connecting belt 31g and at least one clamping part 32g; the connecting belt 31g is connected with the first sub support 1011g and extends out of the first sub support 1011g; the clamping part 32g is connected with the portion of the connecting belt 31g and extended out of the first sub support 1011g, the clamping part 32g may be round in shape or have other suitable shape; the clamping part 32g can be clamped in a gap between the seat cushion 2011 of the back seat assembly 201 and the backrest 2013 of the back seat assembly 201 to fix the first sub support 1011g; the seat support 100g further includes two opposite connecting belts 21g, a connecting part 22g (which may be a clamping seat) and a connecting part 23g (which may be a clamping head), the connecting part 22g and the connecting part 23g are respectively connected with the free ends of the two connecting belts 21g, the connecting belts 21g, the connecting part 22g, the connecting part 23g and the second sub support 1012g cooperatively form the connecting portion 24g, the connecting portion 24g sleeves on the front seat assembly 202; the second sub support 1012g is further provided with a gas charging and discharging member 4g to charge and discharge the second sub support 1012g.

The first sub support 1011g and the second sub support 1012g may be made of different or same materials. A width of the second sub support 1012g can be greater than that of the first sub support 1011g to support the user's legs well.

The second sub support 1012g is protruded with two connecting protrusions 120g, and two connection belts 21g are respectively connected with two connecting protrusions 120g.

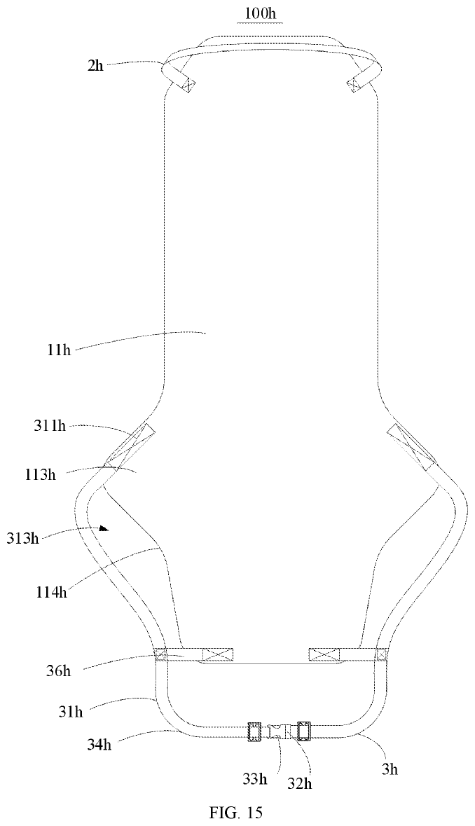

Referring to FIG. 15, the present disclosure provides a seat support 100h according to an eighth embodiment. The seat support 100h is similar to the seat support 100b in structure, and the differences between the two at least include: the support portion 11h includes two convex portions 113h and two recessed portions 114h, the second connecting member 3h includes two connecting belts 31h, a connecting part 32h and a connecting part 33h, and the two connecting belts 31h are connected by the connecting part 32h and the connecting part 33h; the second connecting member 3h further includes two connecting belts 36h for connecting the connecting belt 31h with the support portion 11h; one end of the connecting belt 31h is connected with the convex portion 113h, the connecting belt 31h and the recessed portion 114 and the connecting belt 36h cooperatively form a connecting portion 313h, the safety belt 2016 can pass through the connecting portion 313h; the connecting belt 31h, the connecting belt 36h, the connecting part 32h, the connecting part 33h, and the support portion 11h form the connecting portion 34h which can sleeve around the backrest 2013 of the back seat assembly 201.

The first connecting member 2h is similar with the first connecting member 2b in structure.

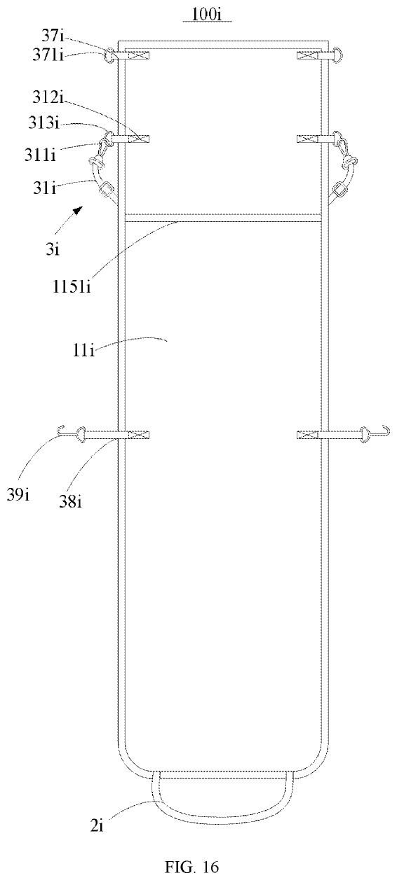

Please referring to FIG. 16, the present disclosure provides a seat support 100i according to a ninth embodiment. The seat support 100i is similar to the seat support 100b in structure, and the differences between the two at least include: the support portion 11i includes a sleeving portion 1151i which has a pocket configured to sleeve on a top portion of the backrest 2013 of the back seat assembly 201; the second connecting member 3i further includes two connecting belts 37i protruded from both ends of the support portion 11i respectively, a free end of the connecting belt 37i is provided with a connecting ring 371i configured to connect with a hook 2014 arranged on the backrest 2013 of the back seat assembly 201; the connecting belt 31i is positioned between the connecting belt 37i and an opening of the sleeving portion 1151i; the connecting belt 31i is provided with a clamping ring 311i, and the clamping ring 311i is detachably clamped with a connecting ring 313i connected with the connecting belt 312i, the connecting belt 312i is arranged between the connecting belt 37i and the connecting belt 31i; the second connecting member 3i further includes two connecting belts 38i and two connecting parts 39i, each connecting part 39i is connected with one connecting belt 38i, and the connecting part 39i can be clamp with the safety belt 2016 or the buckle 2015 of the vehicle.

It should be understood that, the second connecting member 3i sleeves on the backrest 2013 of the back seat assembly 201, the connecting parts 39i are connected with the safety belts 2016 or the buckles 2015 on the backrest 2013, the connecting belts 31i are connected with the front seat assembly 202, the sleeving portion 1151i may be used as a pocket. The first connecting member 2i can sleeve the front seat assembly 202.

The first connecting member 2i is similar with the first connecting member 2b in structure.

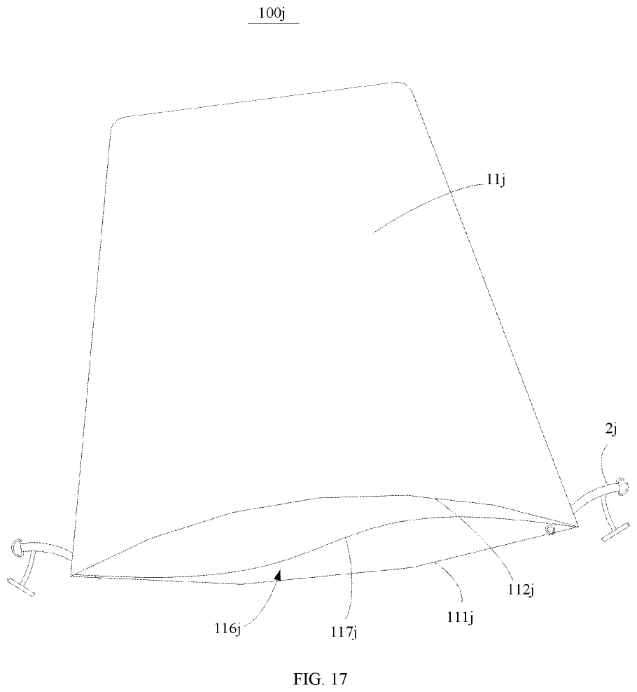

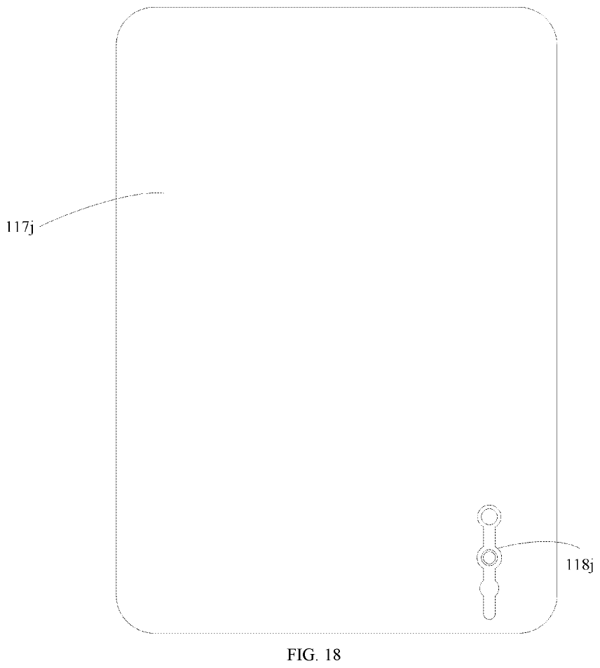

Referring to FIGS. 17-18, the present disclosure provides a seat support 100j according to a tenth embodiment. The seat support 100j is similar to the seat support 100b in structure, and the differences between the two at least include: the seat support 100j does not include a second connecting member, and the first connecting member 2j is connected with the front seat assembly 202; the supporting member 11i has a receiving cavity 116j, the receiving cavity 116j is defined between inner layer 111j and the surface layer 112j and used to receive an airbag 117j, and the airbag 117j is provided with an air charging and discharging part 118j for inflating and deflating the airbag 117j.

Since the support portion 11i further includes an airbag 117j, when the support portion 11i and airbag 117i are placed on the seat cushion 2011 of the back seat assembly 201, the support portion 11i and airbag 117i can be stably placed on the seat cushion 2011 by their own gravity. In addition, user can further fix the support portion 11i and airbag 117j when sitting on the support portion 11i and airbag 117j.

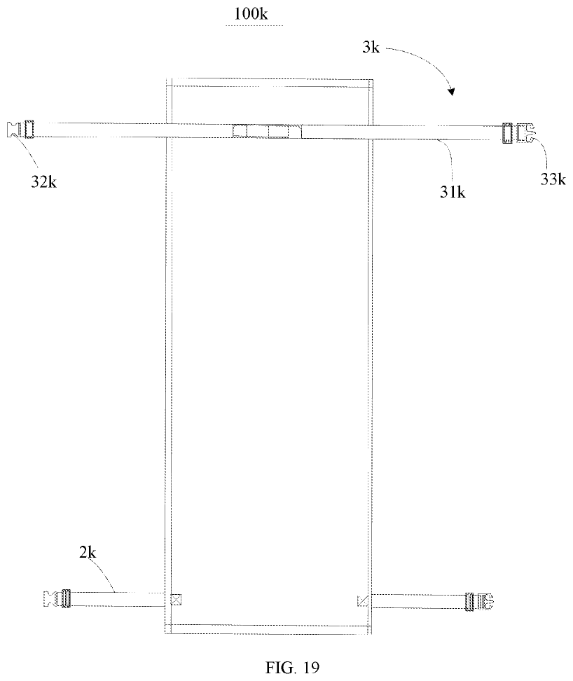

Referring to FIG. 19, the present disclosure provides a seat support 100k according to an eleventh embodiment. The seat support 100k is similar to the seat support 100a in structure, and the differences between the two at least include: the second fixing assembly 3k includes two connecting belts 31k, a connecting part 32k, and a connecting part 33k, the connecting belts 31k are connected with each other by the connecting part 32k and the connecting part 33k.

The first connecting member 2k is similar with the second connecting member 3a in structure.

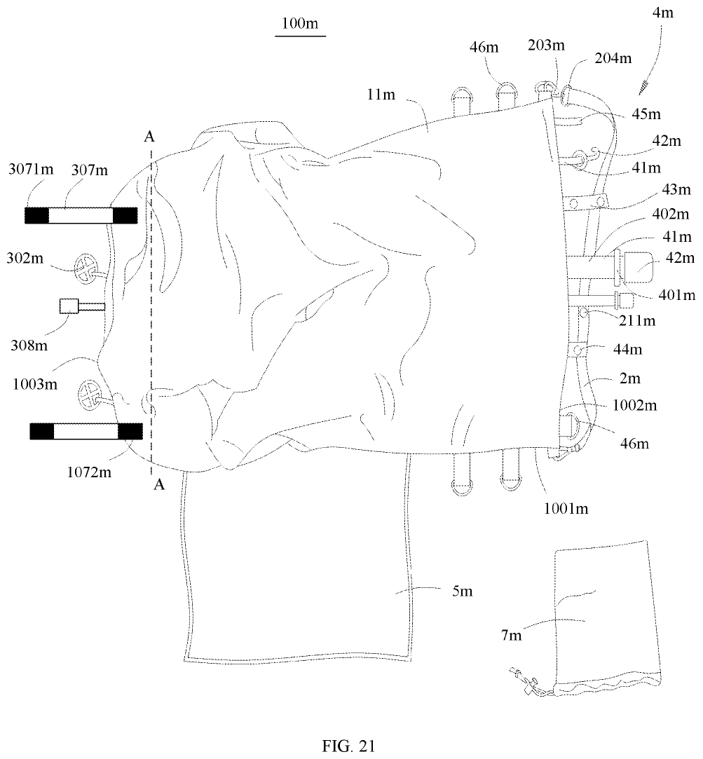

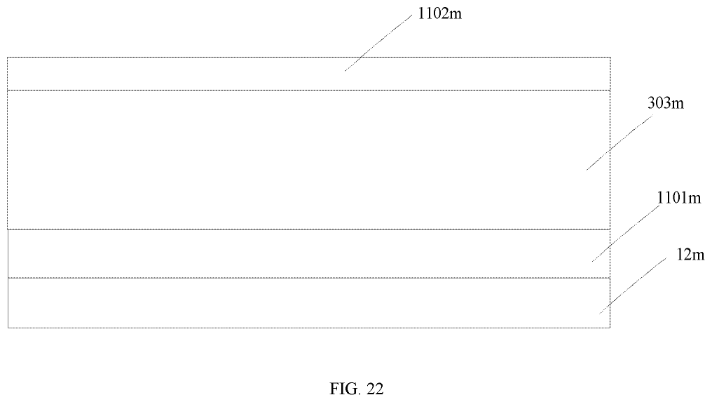

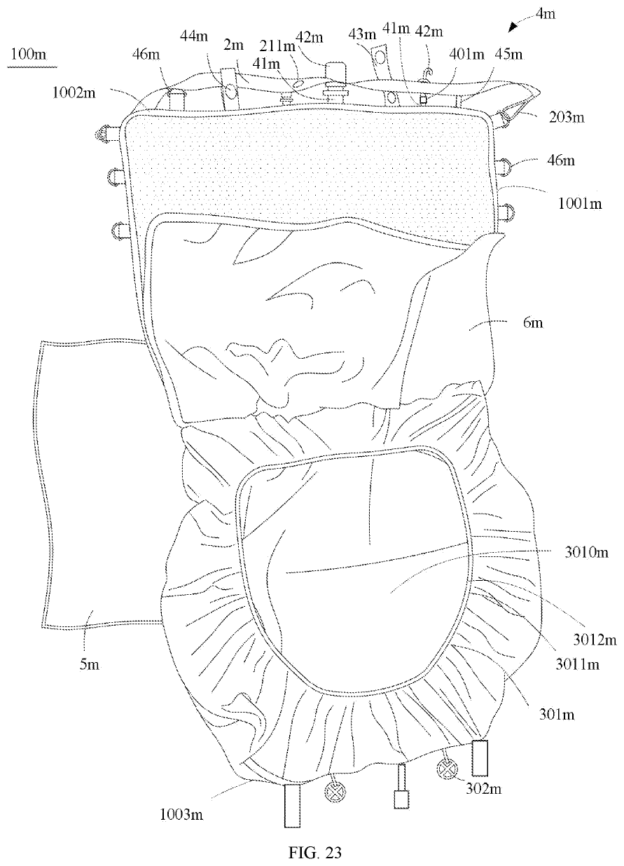

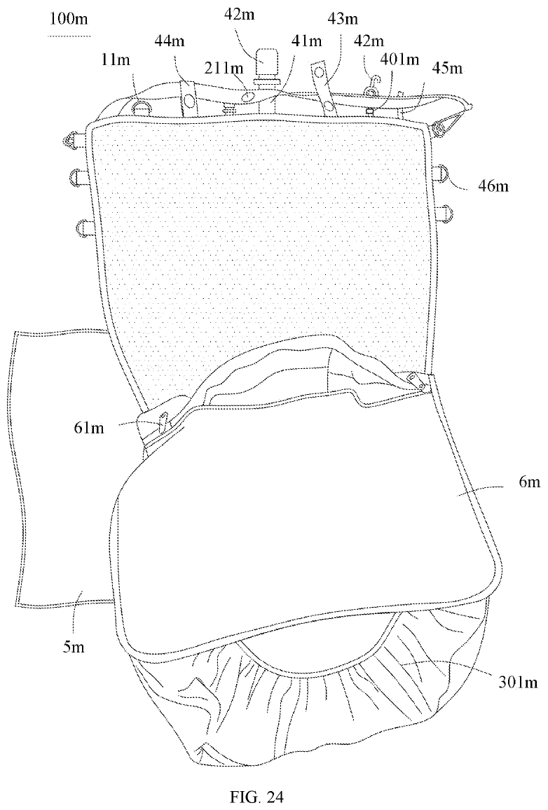

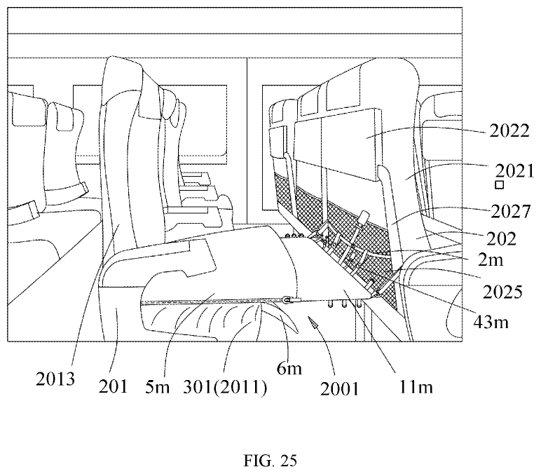

Referring to FIGS. 21 to 27, the present disclosure provides a seat support 100m according to a twelfth embodiment. The seat support 100m is similar to any one of the above seat supports in structure. In one embodiment, the seat support 100m is similar to the seat support 100a in structure. It should be understood that, the seat support 100m can also be similar to the seat support 100b in structure.

The front seat assembly 202 further includes a storage bag 2025, and two support elements 2027 configured for rotatably connecting the table 2022 with the backrest 2021. The first connecting member 2m is connected with the front seat assembly 202 to connect the support portion 11m with the front seat assembly 202. In detail, the first connecting member 2m surrounds the backrest 2021, surrounds the support elements 2027, or surrounds the table 2022, to connect the support portion 11m with the front seat assembly 202.

The seat support 100m further includes an adjusting assembly 4m which is configured to connect the support portion 11m with the front seat assembly 202 at a portion of the support portion 11m to lift the support portion 11m and the prevent the support portion 100m from sagging. The adjusting assembly 4m can keep the support portion 11m substantially at a horizontal position or substantially at a position above the horizontal position, to prevent the support portion 11m from sagging. The adjusting assembly 4m includes a connecting belt 41m sewn or glued with the support portion 11m, and at least one connecting part 42m. One end of the connecting part 42m is connected with the connecting belt 41m. The other end of the connecting part 42m is connected with the backrest 2021, an edge of the storage bag 2025, the table 2022, or the support element 2027 of the front seat assembly 202, for preventing the support portion 11m from sagging. The connecting belt 41m is an elastic belt or an inelastic belt, specifically, the connecting belt 41m is a webbing belt, a plastic belt, a rubber belt, or the like. The connecting part 42m is a hook, a clamp, or the like. The connecting belt 41m is provided with an adjusting buckle 401m configured for adjusting a length of the connecting belt 41m. A portion 402m of the connecting belt 41m can be glued or sewn with the connecting member 2m, or the portion 402m of the connecting belt 41m is not connected with the connecting member 2m. The connecting member 2m defines a through hole 211m, the connecting belt 41m can connect with the front seat assembly 202 or the first connecting member 2m after passing through the through hole 211m.

The adjusting assembly 4m further include a connecting belt 43m sewn or glued with the support portion 11m, and at least two connecting parts 44m arranged on the connecting belt 43m at intervals. One of the at least two connecting parts 44m is connected with another one of the at least two connecting parts 44m according to a gap 2001 between the front seat assembly 202 and the back seat assembly 201 for preventing the support portion 11m from sagging after the connecting belt 43m surrounds the first connecting member 2m or the support element 2027. The connecting belt 43m is an elastic belt or an inelastic belt, specifically, the connecting belt 43m is a webbing belt, a plastic belt, a rubber belt, or the like. The connecting part 44m is a hook, a clamp, a hook and loop fastener, a female buckle, a groove, a hole, or a male buckle, and two of the connecting parts 44m can be connected with each other. After the connecting belt 43m surrounds the first connecting member 2m or the support element 2027, two connecting parts 44m are connected with each other to connect the support portion 11m with the first connecting member 2m or the support element 2027 according to the gap 2001 between the front seat assembly 202 and the back seat assembly 201, for preventing the support portion 11m from sagging.

The adjusting assembly further 4m includes a connecting strip 45m, the connecting strip 45m can be a rope, a chain, or a belt with hook and loop fasteners. One end of the connecting strip 45m is connected with the support portion 11m, and another end of the connecting strip 45m is connected with the support element 2027 or the first connecting member 2m for preventing the support portion 11m from sagging. In one embodiment, the connecting strip 45m is tied with the support element 2027 or the first connecting member 2m.

The adjusting assembly 4m further includes a plurality of connecting parts 46m arranged on the support portion 11m at intervals, the connecting parts 46m can be connected with the support portion 11m by connecting belts (not labeled). Two adjacent connecting parts 46m can contact with each other or can be spaced apart from each other. A first distance between each two adjacent connecting parts 46m is about 0-90 cm, preferably 5-10 cm. In detail, the first distance is 1 cm, 2 cm, 3 cm, 4 cm, 5 cm, 10 cm, 20 cm, 30 cm, 40 cm, 50 cm, 60 cm, 70 cm, 80 cm, or 90 cm. The support portion 11m includes two side edges 1001m, a front edge 1002m, and a rear edge 1003m, the side edges 1001m are substantially parallel with an axis direction of the support portion 11m. The connecting parts 46m are arranged on the side edges 1001m or the front edge 1002m at intervals. Specifically, the front portions of the side edges 1001m are provided with the connecting parts 46m, two ends of the front edge 1002m are provided with connecting parts 46m, users can connect each end of the first connecting member 2m with one of the connecting parts 46m according to the gap 2001 between the front seat assembly 202 and the back seat assembly 201. In this way, the support portion 11m can be remained at a substantially horizontal position or remained at a position substantially above the horizontal position. In one embodiment, the first connecting member 2m includes two connecting parts 203m, the connecting parts 203m are connected with two ends of the first connecting member 2m respectively, the connecting parts 203m are connected with suitable connecting parts 46m according to the gap 2001 between the front seat assembly 202 and the back seat assembly 201 for preventing the support portion 11m from sagging. The connecting part 203m is a hook clasp, a hook buckle, a clamp, a hook and loop fastener, a rope, a groove defined in the first connecting member 2m, a hole defined in the first connecting member 2m, or a female buckle. The connecting part 46m is a hook, a hook buckle, a clamp, a hook and loop fastener, a rope, a groove defined in the support portion 11m, a hole defined in the support portion 11m, or a male buckle. The first connecting member 2m further includes two connecting parts 204m configured to connect the connecting part 203m with the ends of the first connecting member 2m. The connecting part 204m is a connecting ring, a clamp, or a hook. In one embodiment, the connecting part 203m and the connecting part 204 are two independent components, or the connecting part 203m and the connecting part 204m are integratedly formed.

The front edge 1002m is arranged with some elements including at least one connecting belt 41m, at least one connecting belt 43m, at least one connecting strip 45m, and at least one connecting part 46m, each two adjacent elements has a second distance of about 0-60 cm, preferably 3-10 cm. In detail, the second distance is about 1 cm, 2 cm, 3 cm, 4 cm, 5 cm, 10 cm, 20 cm, 30 cm, 40 cm, 50 cm or 60 cm. Two adjacent elements can contact with each other or can be spaced apart from each other.

The seat support 100m further includes a fixing assembly connected with the support portion 11m or received in the support portion 11m. A gap 2010 is defined between the backrest 2013 and the seat cushion 2011 of the back seat assembly 201, the fixing assembly is at least partially received in the gap 2010 to fix the support portion 11m. The fixing assembly includes a wrapping member 301m connected with a lower surface of the support portion 11m, the wrapping member 301m may be a slipcover which covers or surrounds the seat cushion 2011 of the back seat assembly 201 and is partially received in the gap 2010 between the backrest 2013 and the seat cushion 2011 of the back seat assembly 201 to fix the support portion 11m. In detail, the wrapping member 301m surrounds the side surfaces of the seat cushion 2011 and fixed at the bottom surface of the seat cushion 2011, the wrapping member 301m includes a through hole 3010m and an edge 3011m, the edge 3011m is provided with an elastic band 3012m, as such the wrapping member 301m can fix with the bottom surface of the seat cushion 2011. In one embodiment, the elastic band 3012m is arranged along the edge 3011m, and all portions of the edge 3011m are all provided with the elastic band 3012. In another embodiment, only a portion of the edge 3011m is provided with the elastic band 3012m, specifically, the portion of the edge 3011m corresponding to the rear side of the seat cushion 2011 is provided with the elastic band 3012m. In a further embodiment, several separated portions of the edges 3011 are provided with the elastic band 3012m, and at least one of the several separated portions corresponding to the rear side of the seat cushion 2011 is provided with the elastic band 3012m.

The fixing assembly further includes at least one clamping member 302m arranged at the rear edge 1003m of the support portion 11m connected with the support portion 11m by a belt. The clamping member 302m is received or clamped in the gap 2010 between the backrest 2013 and the seat cushion 2011 of the back seat assembly 201 to fix the support portion 11m. The clamping member 302m is round in shape, or the clamping member 302m can have another shapes. In another embodiment, a belt 307m with hook and loop fasteners can also be regarded as the clamping member, the belt 307m with hook and loop fasteners can be received in the gap 2010 to fix the support portion 11m, and the belt 307m with hook and loop fasteners includes a hook portion 3071m and a loop portion 3072m, a ring is formed when the hook portion 3071m is connected with the loop portion 3072m, the safety belt 2016 can pass through the ring to connect the support portion 11m with the back seat assembly 201. In a further embodiment, a clamp 308m can also be regarded as the clamping member, and the clamp 308m is connected with the support portion 11m by a belt.

The fixing assembly further includes an inflatable member 303m, a cushion, or a pillow which can be arranged in a portion of the support portion 11m corresponding to the seat cushion 2011 of the back seat assembly 201. The portion of the support portion 11m for receiving the inflatable member 303m, the cushion, or the pillow can be separated from the other portion of the support portion 11m by seaming the top surface and the bottom surface together along a connecting line of the two portions. It should be understood that, the cushion, the pillow can also be labeled as 303m. A portion of the inflatable member, the cushion, or the pillow can be inserted in the gap 2010 between the backrest 2013 and the seat cushion 2011 of the back seat assembly 201 to fix the support portion 11m. The pillow may be an ice pillow for providing a cool feeling. It should be understood that, the inflatable member, the cushion, or the pillow can also be placed in other positions of the support portion 11m. In one embodiment, the inflatable member may substantially have the shape same with the support portion 11m, that is, the inflatable member takes up all an interior space of the support portion 11m. Obviously, the cushion or the pillow can also have the shape same with the support portion 11m and take up all an interior space of the support portion 11m.

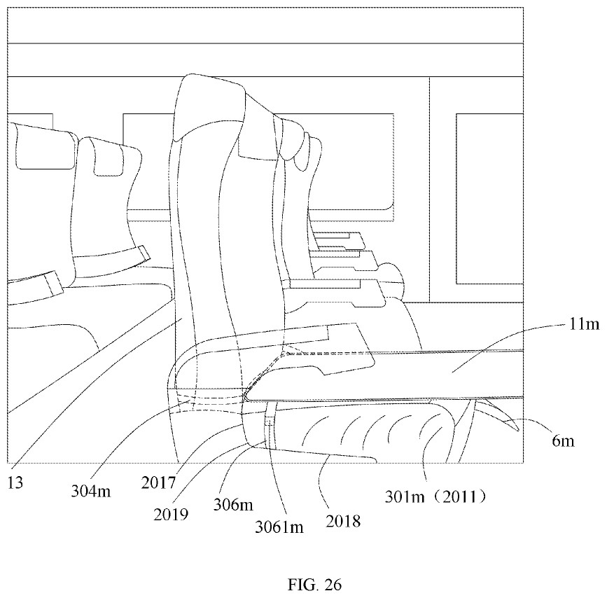

As shown in FIG. 26, the fixing assembly further includes at least one belt which can sleeved on the backrest 2013 or the seat cushion 2011 of the back seat assembly 201. In one embodiment, the at least one belt includes an elastic belt 304m and a non-elastic belt 306m, the non-elastic belt 306m has a connecting structure 3061m, the connecting structure 3061m can be a clamping structure, and the non-elastic belt 306m has the same structure as the first connecting member or the second connecting member recited in the first to eleventh embodiments. In one embodiment, the elastic belt 304m or the non-elastic belt 306m can sleeve on the backrest 2013, or can be received in the gap 2010 and surrounds a rear surface 2017 of the seat cushion 2011, or can sleeve on the side surface 2018 of the seat cushion 2011 after passing through the gap 2010, or can be received in the gap 2010 and surrounds a connecting portion 2019 of the rear surface 2017 and the side surface 2018.

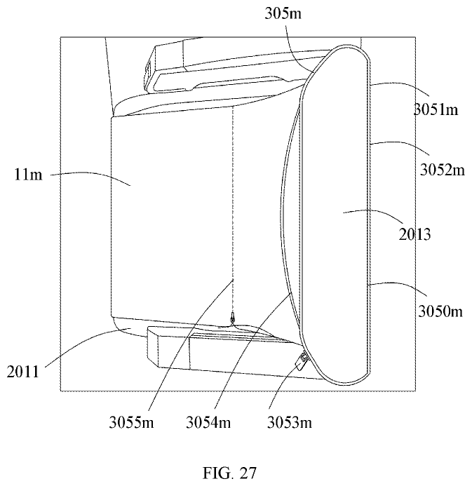

As shown in FIG. 27, the fixing assembly further includes a sleeve 305m which can surround the backrest 2013 of the back seat assembly 201. The sleeve 305m can surround all or part of the backrest 2013 of the back seat assembly 201, the shape of the sleeve 305m can be designed according to actual needs. The sleeve 305m has two opposite through holes 3051m and an inner space 3050m for receiving the backrest 2013, an edge of one of the through holes 3051m is connected with the support portion 11m, and a periphery of each of the through holes 3051m is provided with an elastic part 3052m. In detail, a portion of the edge of the through hole 3051m which is not connected with the support portion 11n is provided with the elastic part 3052m. The sleeve 305m is further provided with a zipper 3053m parallel with the axis of the backrest 2013 when the sleeve 305m surrounds the backrest 2013. User can surround the sleeve 305m on the backrest 2013 easily by the zipper 3053n. The sleeve 305m has a bag 3054m for receiving the belongings of the user. In one embodiment, the sleeve 305m is integratedly with the support portion 11m. In another embodiment, the sleeve 305m and the support portion 11m are two independent components, and connected with each other by a zipper 3055m.

The seat support 100m further includes a blanket 5m connected with the support portion 11m. The blanket 5m may be detachably or fixedly connected with the side edge 1001m, the front edge 1002m or the rear edge 1003m of the support portion 11m. The blanket 5m can be connected with the side edge 1001m by a zipper. The blanket 5m can keep the child from catching a cold.

The seat support 100m further includes a bag 6m connected with the lower surface of the support portion 11m, the bag 6m is configured to receive belongings of user, and the bag 6m is also configured to receive the support portion 11m, the first connecting member 2m, the adjusting assembly 4m, the blanket 5m, the fixing assembly when the support portion 11m is not connected with the front seat assembly 202. In detail, a portion of the support portion 11m which is not arranged on the seat cushion 2011 can be received in the bag 6m when the support portion 11m is not connected with the front seat assembly 202. The bag 6m has an opening and a receiving space, and the bag 6m can be opened or closed by a zipper 61m. The bag 6m is substantially arranged at a middle portion of the lower surface of the support portion 11m, and perpendicular to an axis direction of the support portion 11m. When the seat support 100m is in use, the bag 6m rests on the seat cushion 2011 of the back seat assembly 201. In another embodiment, the bag 6m can also be arranged at the side edge 1001m of the support portion 11m.

The seat support 100m further includes a buggy bag 7m, the support portion 11m, the connecting member 2m, the fixing assembly, the blanket 5m, the bag 6m can be received in the buggy bag 7m when not in use.

The seat support 100m further includes an anti-skid portion 12m arranged on the back side 1101m of the support portion 11m. The anti-skid portion 12a is an anti-skid layer arranged on the back side 1102m and the anti-skid layer 12m is made of an anti-skid material, such as silicone, rubber, nylon, and woven materials with rough surfaces. The inflatable member 303m is arranged between the back side 1001m and the front side 1002m.

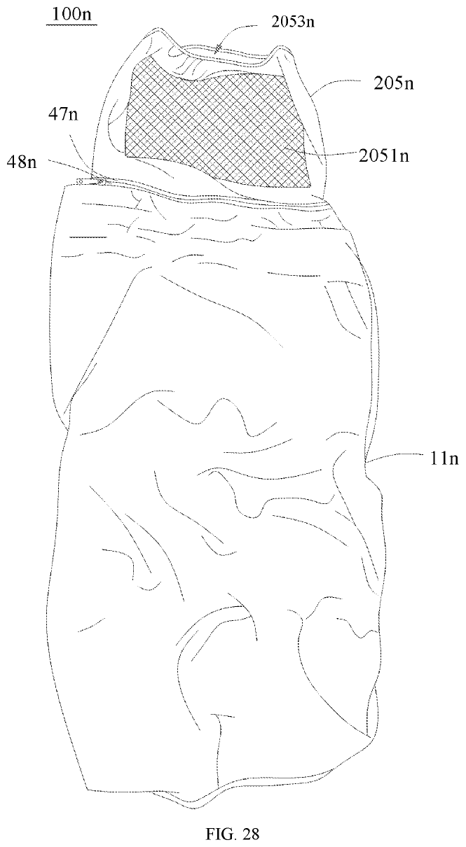

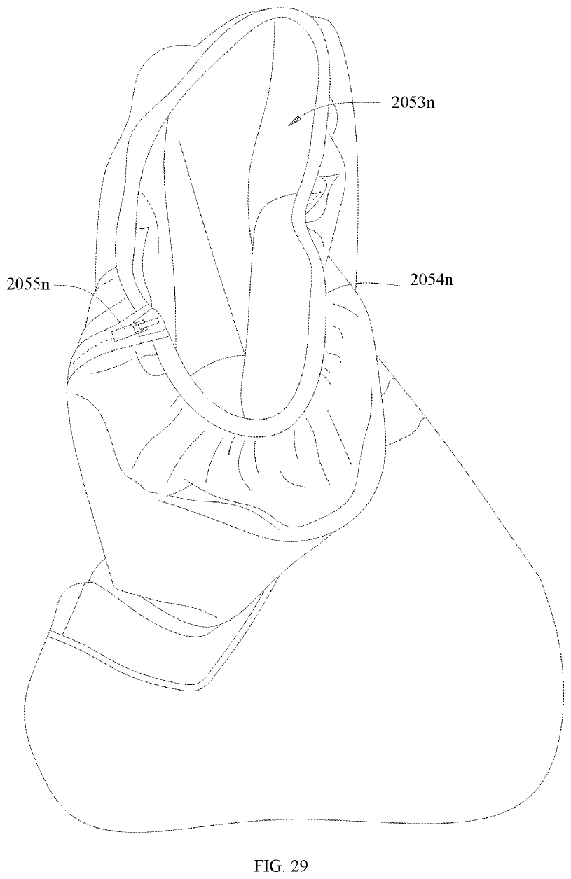

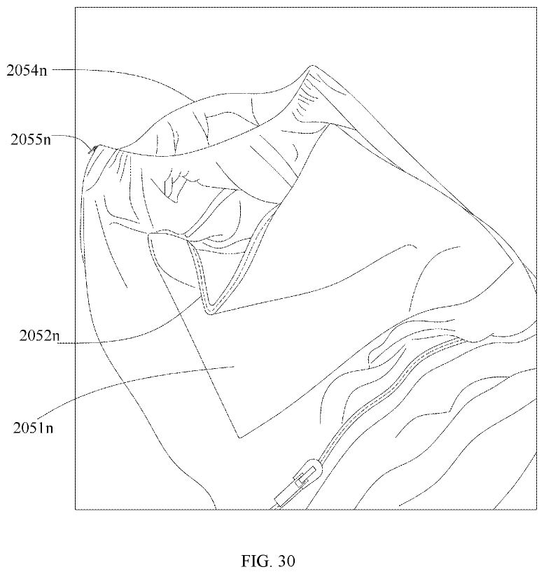

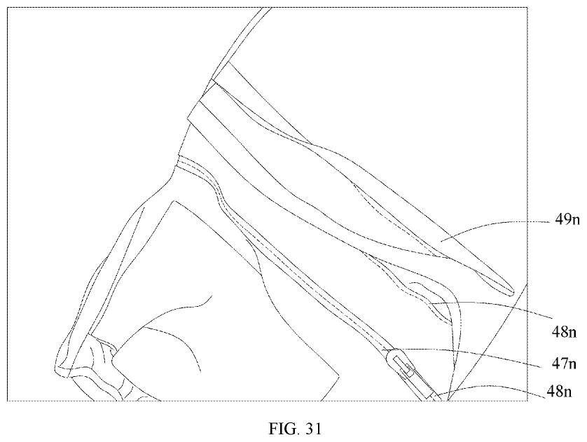

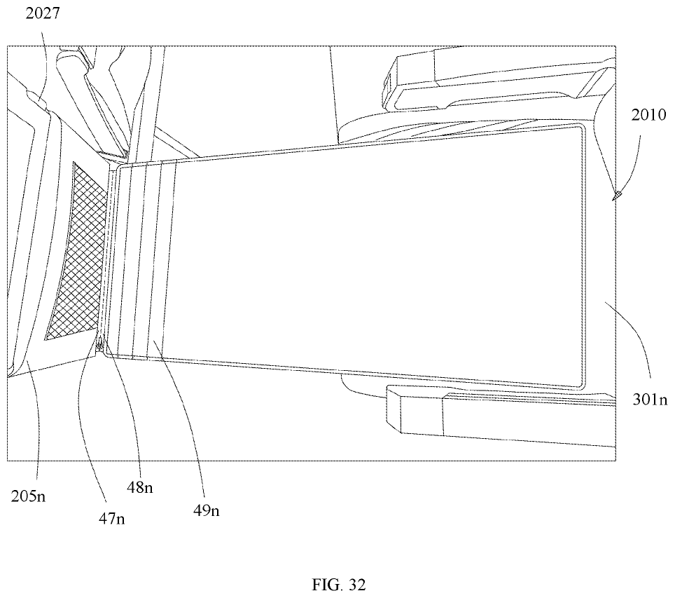

Referring to FIGS. 28 to 34, the present disclosure provides a seat support 100n according to a thirteenth embodiment. The seat support 100n is similar to seat support 100m in structure. The difference between the two at least includes: the first connecting member 2n further includes a sleeve 205n connected with the support portion 11n, the sleeve 205n is sleeved on the support elements 2027 or the table 2022 to connect the first connecting member 2n with the front seat assembly 202.

The sleeve 205n includes a bag 2051n, the bag 2051n is configured to receive belongings of user, the bag 2051n can also be configured to receive the support portion 11n, the first connecting member 2n and the adjusting assembly 4n when the support portion 11n is not connected with the front seat assembly 202. The bag 2051n can be closed or opened by a zipper 2052n. In another embodiment, the sleeve 205n does not have the bag 2051n.

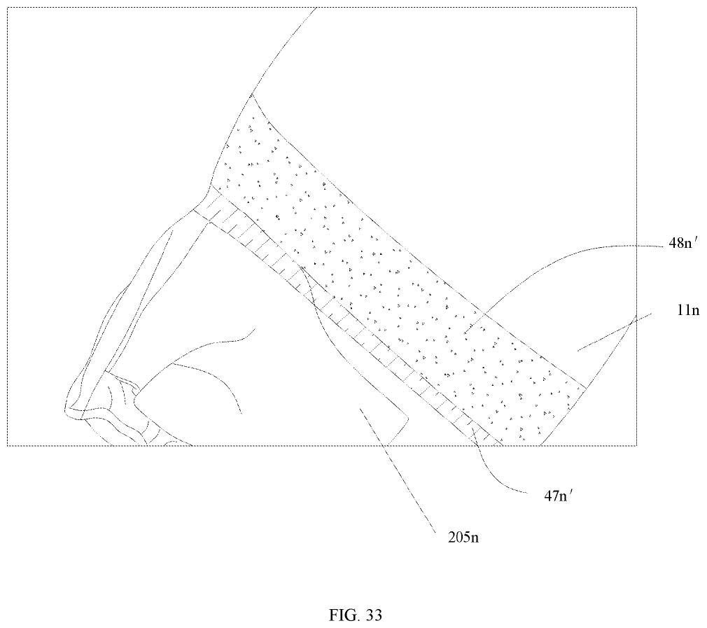

The adjusting assembly 4n includes a connecting part 47n arranged on sleeve 205n, and at least one connecting parts 48n arranged on the support portion 11n. The connecting part 47n is arranged perpendicular to the axis of the support portion 11n, and the connecting parts 48n is also arranged perpendicular to the axis of the support portion 11, a width of the connecting part 47 is substantially equal to that of the sleeve 205n, and a width of the connecting part 48n is also substantially equal to that of the sleeve 205n. In one embodiment, as shown in FIGS. 28-32, the adjusting assembly 4n includes a connecting part 47n and a plurality of connecting parts 48n which are all perpendicular to the axis direction of the support portion 11n, the connecting part 47n is connected with one of the connecting parts 48n according to the gap 2001 between the front seat assembly 202 and the back seat assembly 201, so as to connect the support portion 11n with the sleeve 4n and prevent the support portion 11m from sagging. The seat support 100n further include a plurality of covers 49n, each cover 49n is connected with the support portion 11n and configured to cover or expose the corresponding connecting part 48n. In another embodiment, as shown in FIG. 33, the adjusting assembly 4n includes a connecting part 47n′ and a connecting part 48n′, the connecting part 47n′ and connecting part 48n′ are hook and loop fasteners and perpendicular to the axis direction of the support portion 11n, an area of the connecting part 48′ is larger that of the connecting part 47n′.

The sleeve 205n has two opposite through holes 2053n, an edge of one of the through holes 2053n adjacent to the support portion 11n is provided with the connecting part 47n, and a periphery of each of the through holes 2053n is provided with an elastic part 2054n for preventing the sleeve 205n from escaping from the support portion 11n. In Detail, a portion of the edge of the through hole 2053n adjacent to the support portion 11n is provided with the connecting part 47n, and another portion of the through hole 2053n adjacent to the support portion 11n is provided with elastic part. The sleeve 205n is further provided with a zipper 2055n perpendicular to the axis of the support elements 2027 when the sleeve 205n surrounds the support elements 2027. User can surround the sleeve 205n on the support elements 2027 easily by the zipper 2055n.

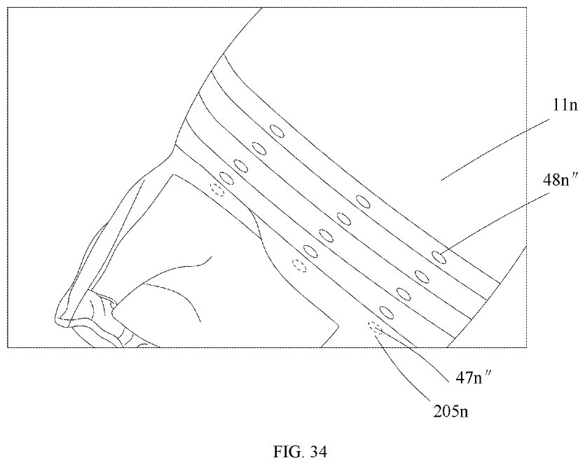

The connecting part 47n is a sub-part of a zipper, a hook and loop fastener, a female buckle set, a button set, a clamp, a groove, or a hole. Each of the connecting part 48n is another sub-part of the zipper, a hook and loop fastener, a male buckle set, a button set, a clamp, a groove, or a hole. As shown in FIG. 34, the connecting part 47″ may be button, a female buckle, a button set, a groove, or a hole, and the connecting part 48″ may be button, a female buckle, a button set, a groove, or a hole.

The seat support 100n also includes the anti-skip portion 12m, the blank 5m, the fixing assembly, the bag 6m, the clamping member 302m, the inflatable member 303m, the cushion, and the pillow as recited in seat support 100m.

The above description is merely some embodiments. It should be noted that for one with ordinary skills in the art, improvements can be made without departing from the concept of the present disclosure, but these improvements shall fall into the protection scope of the present disclosure.

What is claimed is:

1. A seat support, applied to a vehicle having a front seat assembly and a back seat assembly, wherein the seat support comprises:
a support member, comprising:
a support portion, arranged on the back seat assembly; and
a connecting member, arranged on the support portion and configured to connect the support portion with the front seat assembly; and
a fixing assembly, arranged on the support portion and configured to fix the support portion with the back seat assembly.

2. The seat support according to claim 1, wherein the back seat assembly comprises a seat cushion, the fixing assembly comprises a wrapping member connected with the support portion, the wrapping member surrounds at least a part of the seat cushion to fix the support portion on the seat cushion.

3. The seat support according to claim 2, wherein the wrapping member defines a through hole, at least a portion of an edge of the through hole is provided with an elastic part, and the wrapping member surrounds at least a rear side of the seat cushion of the back seat assembly.

4. The seat support according to claim 1, wherein the back seat assembly comprises a backrest and a seat cushion, a gap is defined between the backrest and the seat cushion of the back seat assembly, the fixing assembly further comprises a clamping member connected with the support portion, an inflatable member received in the support portion, a cushion received in the support portion, or a pillow received in the support portion, the clamping member, the inflatable member, the cushion, or the pillow is at least partially received in the gap to fix the support portion.

5. The seat support according to claim 1, wherein the back seat assembly comprises a backrest, the fixing assembly further comprises a first sleeve connected with the support portion, the first sleeve is sleeved on the backrest.

6. The seat support according to claim 5, wherein the first sleeve comprises a through hole and an inner space, the backrest is received in the inner space through the through hole.

7. The seat support according to claim 1, wherein the back seat assembly comprises a backrest and a seat cushion, the fixing assembly further comprises at least one belt connected with the support portion, the at least one belt is sleeved on the backrest or the seat cushion.

8. The seat support according to claim 7, wherein a gap is defined between the backrest and the seat cushion of the back seat assembly, the at least one belt is sleeve on the backrest, or received in the gap and sleeved on the seat cushion, or sleeved on the seat cushion after passing through the gap.

9. The seat support according to claim 1, further comprising:
an adjusting assembly, configured to connect the support portion with the front seat assembly according to a gap between the front seat assembly and the back seat assembly to prevent the support portion from sagging.

10. The seat support according to claim 9, wherein the front seat assembly comprises a backrest, a storage bag, a table, and at least one support element configured for rotatably connecting the table with the backrest, the adjusting assembly comprises:
a first connecting belt, connected with the support portion; and
at least one first connecting part, connected with the first connecting belt, the first connecting part is connected with the backrest, the storage bag, the table or the at least one support element of the front seat assembly for preventing the support portion from sagging.

11. The seat support according to claim 9, wherein the front seat assembly comprises a backrest, a table, and at least one support element configured for rotatably connecting the table with the backrest, the adjusting assembly comprises:
a second connecting belt, connected with the support portion; and
at least two second connecting parts, arranged on the second connecting belt, one of the at least two second connecting parts is connected with another one of the at least two second connecting parts according to a gap between the front seat assembly and the back seat assembly for preventing the support portion from sagging after the second connecting belt surrounds the connecting member or the at least one support element.

12. The seat support according to claim 9, wherein the front seat assembly comprises a backrest, a table, and at least one support element configured for rotatably connecting the table with the backrest, the adjusting assembly comprises:
a connecting strip, one end of the connecting strip is connected with the support portion, and another end of the connecting strip is connected with the table or the at least one support element for preventing the support portion from sagging.

13. The seat support according to claim 9, wherein
the adjusting assembly comprises a plurality of third connecting parts arranged on the support portion at intervals; and
the connecting member comprises two fourth connecting parts, the two fourth connecting parts are respectively connected with two of the third connecting parts for preventing the support portion from sagging.

14. The seat support according to claim 1, wherein the front seat assembly comprises a backrest, a table, and at least one support element configured for rotatably connecting the table with the backrest, the connecting member comprises:
a sleeve connected with the support portion, the sleeve is sleeved on the at least one support element to connect the connecting member with the front seat assembly.

15. The seat support according to claim 14, wherein the sleeve comprises a first bag configured to receive belongings of user.

16. The seat support according to claim 14, wherein the adjusting assembly comprises comprises:
a fifth connecting part, arranged on sleeve; and
at least one sixth connecting part, arranged on the support portion, the fifth connecting part is connected with the at least one sixth connecting part to connect the support portion with the sleeve.

17. The seat support according to claim 1, further comprising:
a blanket, connected with the support portion.

18. The seat support according to claim 1, further comprising:
a second bag, connected with the support portion, the second bag is configured to receive belongings of user, or the second bag is configured to receive the support portion, the connecting member and the adjusting assembly when the support portion is not connected with the front seat assembly.

19. A seat support, applied to a vehicle having a front seat assembly and a back seat assembly, wherein the seat support comprises:
a support member, comprising:
a support portion, arranged on the back seat assembly; and
a connecting member, arranged on the support portion and configured to connect the support portion with the front seat assembly; and
an adjusting assembly, configured to connect the support portion with the connecting member at a region of the support portion to prevent the support portion from sagging.

20. A seat support, applied to a vehicle having a front seat assembly and a back seat assembly, wherein the seat support comprises:
a support member, comprising:
a support portion, arranged on the back seat assembly; and
a connecting member, arranged on the support portion and configured to connect the support portion with the front seat assembly; and
an adjusting assembly, configured to connect the support portion with the front seat assembly at a portion of the support portion according to a gap between the front seat assembly and the back seat assembly to prevent the support portion from sagging.
